(19) United States
(12) Patent Application Publication
(10) Pub. No.: US 2006/0239025 A1
(43) Pub. Date: Oct. 26, 2006

(54) Luminous panel and the use thereof for video display screens

(76) Inventors: Bernard Azorin, Montauban (FR); Didier Azorin, Montauban (FR)

Correspondence Address: YOUNG & THOMPSON, 745 SOUTH 23RD STREET, 2ND FLOOR, ARLINGTON, VA, 22202, US

(21) Appl. No.: 10/566,710

(22) PCT Filed: Jul. 27, 2004
(86) PCT No.: PCT/FR04/02003

§ 371 Date: Feb. 1, 2006

(30) Foreign Application Priority Data
Aug. 5, 2003 (FR) 03/09639

(51) Int. Cl. B64D 47/06

(52) U.S. Cl. 362/559; 362/616

(57) ABSTRACT

A luminous panel includes a transparent plate provided with two opposite flat surfaces which are connected by an edge surface, a reflecting surface which is disposed oppositely with respect to the surface at a nonzero distance in such a way that a transparent medium blade whose optical index is less than that of the plate material is formed, and source facilities which radiate light beams, are arranged on the periphery of the plate and the surface and connected to each other in order to direct a part of the light beams towards the edge surface and another part of the light beams to the blade in such a way that a portion of the part of the beams is reflected from the surface and returned towards the surface. The luminous panel can be used for producing large-sized flat video screens.

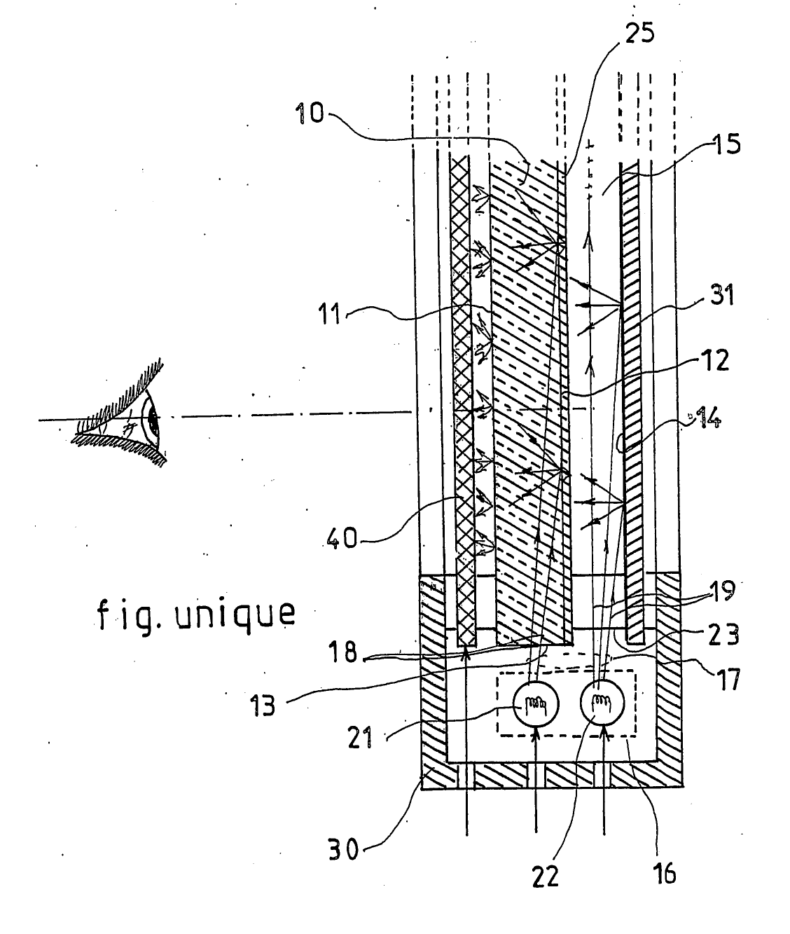

The present invention relates to luminous panels as well as, by way of application of these panels, display screens, for example video, more especially television.

It is well known that, currently, the use of luminous panels is found in all fields, since more and more recourse is made to images as information vectors for the general public.

Such is substantially the case in the field of publicity, but also in that of industry, entertainment, media, etc.

In order to be able to reach the greatest possible public, but also to be able to be seen further and further away, there is a tendency to use luminous panels and/or display screens of larger and larger dimensions.

However, it is quite clear that, for the information displayed by these panels to be perfectly visible, their luminosity must be sufficient and as homogeneous as possible over the whole of their surface.

To overcome this problem, the production of these panels has substantially consisted of multiplying the light sources illuminating them, by disposing them at the rear relative to their display surface, at distances which are substantially proportional to the dimensions of the panels.

Because of this, the bulk of this type of panel, in a direction perpendicular to their display surface, is sometimes very considerable, and this contributes to limiting the use of these panels. In addition, the complexity of the combination of the number of light sources and the elements for managing their operation considerably increases their production cost.

The problem of the panels of small and average dimensions has been solved relatively easily, for example by the embodiment described and illustrated in International Application WO00/12930 in the name of the Applicants. But a film intended to distribute the light in a uniform manner, such as the film referenced 20 in the drawings of the document cited above, does not permit a completely satisfactory luminosity to be obtained when the panels have large dimensions.

The object of the present invention, therefore, is to produce a luminous panel which has improved luminosity whilst having a relatively low production cost and a bulk in depth which is as small as possible.

More precisely, the object of the present invention is a luminous panel, characterised by the fact that it comprises:
at least one plate, formed from a material capable of transmitting, at least partially, light emitted in the visible spectrum, said plate comprising two opposite planar faces, a first face and a second face, connected at their periphery by an edge face, said first face constituting the display face of the panel,
a surface disposed facing the second planar face at a non-zero distance so as to form, between itself and this said second planar face, a layer of a transparent medium with an optical index lower than that of the material constituting said plate, and
light source means capable of emitting light beams, at least in the visible spectrum, said light source means being substantially situated at the periphery of said plate and of said reflecting surface and designed to direct a first portion of the light beams towards said edge face and a second portion of said light beams into said layer, so that at least a portion of this second portion of light beams is reflected on said reflecting surface to be sent back towards said second planar face of said plate.

According to an advantageous characteristic, said layer of a transparent medium with an optical index lower than that of the material constituting said plate is a layer of air.

According to another advantageous characteristic, the light source means, capable of emitting light beams, are constituted by at least two light source sub-assemblies, each of these sub-assemblies being respectively situated facing the edge face of the plate and facing the edge of the layer, so that the beams emitted by these two light source sub-assemblies constitute the two said first and second portions of light beams respectively.

According to another advantageous characteristic, said reflecting surface is of the granular type in order to encourage at least one of the two following optical phenomena: reflection and diffusion.

According to another advantageous characteristic, the luminous panel according to the invention comprises, in addition, a layer for distributing the light being propagated in the plate.

According to an advantageous characteristic, said light distribution layer is in contact with the second planar face of the plate.

According to an advantageous characteristic, said plate is constituted by a plate formed from at least one of the following materials: organic glass, PMMA.

The object of the present invention is also to produce a display screen of the video type, making use of the luminous panel according to the invention, characterised by the fact that it comprises:
at least one plate, formed from a material capable of transmitting, at least partially, light emitted in the visible spectrum, said plate comprising two opposite planar faces, a first face and a second face, connected at their periphery by an edge face, said first face constituting the display face of the panel,
a reflecting surface disposed facing the second planar face at a non-zero distance so as to form, between itself and this said second planar face, a layer of a transparent medium with an optical index lower than that of the material constituting said plate,
light source means capable of emitting light beams, at least in the visible spectrum, said light source means being substantially situated at the periphery of said plate and of said reflecting surface and designed to direct a first portion of the light beams towards said edge face and a second portion of said light beams into said layer, so that at least a portion of this second portion of light beams is reflected on said reflecting surface to be sent back towards said second planar face of said plate, and
an active matrix situated facing the first face of said plate.

Other characteristics and advantages of the present invention will appear in the course of the following description, given with reference to the accompanying drawing by way of illustration but in no way limitingly, in which the single FIGURE illustrates, in a partial cross-sectional view, a preferred embodiment of a display screen which makes use of the luminous panel according to the invention.

It is first of all specified that the FIGURE only represents one embodiment of the subject-matter according to the invention, but other embodiments can exist which correspond to the definition of this invention.

It is also specified that when, according to the definition of the invention, the subject-matter of the invention includes “at least one” element which has a given function, the embodiment described may comprise a plurality of these elements.

Conversely, if the embodiment of the subject-matter according to the invention, such as illustrated, comprises a plurality of elements of identical function, and if, in the description, it is not specified that the subject-matter according to this invention must of necessity comprise a particular number of these elements, the subject-matter of the invention will be able to be defined as comprising “at least one” of these elements.

Finally, it is specified that when, in the present description, an expressions defines, in itself, without particular specific mention concerning it, an assembly of a structural characteristics, [for example, Σ=Σ(α, β, γ, --)], these characteristics may be taken, for the definition of the subject-matter of the protection applied-for, when this is technically possible, either separately, [for example, α, and/or β, and/or γ, --], or in total and/or partial combination [for example, Σ(α,β,γ) and/or Σ(α,β), and/or Σ(β,γ), and/or Σ(α,γ)].

This having been specified, the single FIGURE illustrates, in a partial cross-sectional view, a preferred embodiment of a display screen which makes use of the luminous panel according to the invention.

The luminous panel comprises at least one plate 10, formed from a material capable of transmitting, at least partially, light emitted in the visible spectrum, this plate 10 comprising two opposite planar faces, a first face 11 and a second face 12, connected at their periphery by an edge face 13, its first face 11 constituting the display face of the panel.

Such a plate is known in itself and may, for example, be constituted by a plate formed from organic glass or from PMMA or the like, for example a material known under the trade names “Altuglas”, “Plexiglas”, etc. or the like. It is generally of a rectangular parallelepiped configuration, although it may take any other form, more especially a form adapted to the purpose which the luminous panel is intended to serve.

To support this plate, a frame 30 is generally provided which surrounds it in a manner known in itself, the structure of which will not therefore be described here with the sole purpose of simplifying the present description.

The panel according to the invention comprises in addition a reflecting surface 14, produced on a rigid support 31 of any kind, the support itself also being secured on the frame 30. This reflecting surface 14 is disposed facing the second planar face 12 at a non-zero distance so as to form, between itself and this said second planar face, a layer 15 of a transparent medium with an optical index lower than that of the material in which the plate 10 is made.

In an advantageous embodiment, more especially for its production cost, this layer 15 of a transparent medium with an optical index lower than that of the material in which the plate 10 is made is a layer of air.

It is stressed that, in the sense of the definition of the invention and of the present description, the term reflecting, which qualifies the surface 14, must be understood as covering the phenomenon of optical reflection itself but also the phenomenon of diffusion. This surface 14 may be smooth or granulated.

The panel also comprises light source means 16 capable of emitting light beams 17, at least in the visible spectrum. These light source means are substantially situated at the periphery of the plate 10 and of the reflecting surface 14 and are designed to direct a first portion 18 of the light beams 17 towards the edge face 13 and a second portion 19 of these light beams into the layer 15, so that at least a portion of this second portion 19 of light beams is reflected on the reflecting surface 14 and/or diffused on this surface to be sent back towards the second planar face 12 of the plate 10.

According to one possible embodiment, these light source means 16, which are capable of emitting light beams 17 at least in the visible spectrum, are constituted by lamps or the like, in a form adapted to that of the periphery of the plate 10, so as to be able to be disposed along the edge face 13.

In the case of a plate 10 of rectangular parallelepiped configuration, as mentioned above, these lamps are advantageously constituted by tubes, and may be disposed on at least one of the sides of the plate 10, preferably on two opposite sides, or on the four sides as explained hereinafter.

In an advantageous embodiment, to improve the total viability of the light panel according to the invention, as illustrated in the single FIGURE, these light source means 16, capable of emitting light beams 17, are constituted by two light source sub-assemblies 21, 22, each of these sub-assemblies being respectively situated facing the edge face 13 of the plate 10, and facing the edge 23 of the layer 15, so that the beams emitted by these two light source sub-assemblies constitute the two portions of light beams 18, 19 respectively, defined previously.

Such light sources or lamps may be constituted, for example, by lighting tubes of the fluorescent type, LEDs, neon tubes or the like.

The light source sub-assembly 21, situated opposite the edge face 13 of the plate 10, will advantageously be made up of two light tubes placed on two opposite edges of the plate 10, or by four tubes placed respectively on the four opposite edges, and the light source sub-assembly 22, situated opposite the edge face 23 of the layer 15, will advantageously be composed of two light tubes placed on two opposite edges of the layer 15 or of four tubes placed respectively on the four opposite edges. The sub-assemblies 21 and 22 may be constituted respectively by a number of different light tubes, more especially because of the presence of a light distribution layer, as explained below.

In an embodiment which is improved in respect of the embodiment described above and illustrated in the single FIGURE, the light panel according to the invention may advantageously comprise in addition a layer 25 for distributing the light being propagated in the plate 10 and diffused at the first face 11, for example, but not solely, of the same type as that which is described and illustrated under the reference “20” in the accompanying drawings for the international application mentioned in the preamble of the present description, namely a distribution layer comprising a plurality of bands of relatively small width in the vicinity of the light source and with a width which increases towards the centre of the plate 10. In this case, the light source sub-assembly 21, placed facing the edge 13 of the plate, will advantageously be constituted by two light tubes placed facing the two opposite edges of the plate, corresponding to the start of the bands of the light distribution layer. The distribution layer 25, which permits the light to be conducted like a light wave guide, will be able to be produced in any known manner, for example in a unitary manner or not, by the superposition of a plurality of layers or by a single layer, with special structural embodiments, for example by a mixture of a glue and white pigments adhering to the second face 12 of the plate 10, or by engraving carried out on the second face of the plate 10, different distributions of the light of the points type, bands type, etc.

This light distribution layer 25 is situated, as illustrated in the single FIGURE, in contact with the second planar face 12 of the plate 10. It permits a better distribution of the light, being propagated in the plate 10, to be obtained, by increasing the quantity of light at the centre of the plate to compensate for the losses of light due to the phenomenon of absorption which is produced when the light beams are propagated in the plate and towards its centre. The layer 25 will be produced in a material capable of transmitting at least partially the light emitted in the visible spectrum.

The light panel according to the invention operates in the following manner:

The two light sources 21, 22 respectively emit their light beams 18, 19 respectively towards the edge face 13 and the layer of air 15.

The light beams 18, striking the edge face 13, are propagated in the plate 10 and, by means of the dioptre which constitutes the second face 12 of the plate 10 with the distribution layer 25, they are diffused in the plate to illuminate all of the first face 11, as explained more especially in the international application cited previously.

Because of the large dimensions of the plate 10, a not negligible absorption of the light energy is produced in the material constituting this plate, which absorption is not totally compensated-for by the presence of the light distribution layer 25, and the luminosity on the front display face 11 is therefore never perfectly homogeneous.

But the light beams 19, which are propagated in the layer of air 15, which, itself, is very non-absorbent, are reflected virtually totally and/or diffused on the reflecting surface 14, and illuminate, via the distribution layer 25, all of the second face 12 of the plate 10 in a relatively homogeneous manner.

The two light densities, those relating to the beams 18 and the beams 19 respectively, cause a synergy effect which defines a total light density, the relative variations of which are much weaker than those of the light density corresponding to the single light beams 18.

Because of this, the luminosity of the front face 11 has good homogeneity and good intensity over all of its surface, the slight possible variations or diminutions inherent in the first portion of beams 18 being strongly attenuated or compensated-for.

The description above applies to the structure of a static or analog light display panel, for example such as those which are used in the field of publicity or the like and which are of the type of that described in the international application referred to in the preamble of the present description.

However, as mentioned previously, the light panel according to the invention finds a particularly advantageous application for producing a display screen, more especially video, in particular a television screen, of the “flat” type and with large dimensions, for example from 50 cm long depending on requirements.

The display screen according to the invention, which is schematically illustrated in the single FIGURE, comprises a panel which has the structure described above and, facing the first display face 11, an active matrix 40, which is also secured on the frame 30. This active matrix 40 is of the type of that which is found in current video screens, comprising in known manner black and/or colour pixels. Such active matrices are well-known in themselves and are used in known display screens of the LCD screen type, and will not, in consequence, be described more fully here.

Since the active matrix 40 is associated with the light panel according to the invention, described previously, it is perfectly illuminated, and above all in a homogeneous manner over all of its surface, by the light emerging from the first face 11 of the plate 10, and therefore permits video screens to be produced which have a luminosity of very good quality, even if they are of large dimensions, but with relatively small depths or thicknesses and reduced manufacturing costs.

1. Luminous panel, characterised by the fact that it comprises:
at least one plate (10), formed from a material capable of transmitting, at least partially, light emitted in the visible spectrum, said plate comprising two opposite planar faces, a first face (11) and a second face (12), connected at their periphery by an edge face (13), said first face (11) constituting the display face of the panel,
a reflecting surface (14) disposed facing the second planar face (12) at a non-zero distance so as to form, between itself and this said second planar face, a layer (15) of a transparent medium with an optical index lower than that of the material constituting said plate (10), and
light source means (16) capable of emitting light beams (17), at least in the visible spectrum, said light source means being substantially situated at the periphery of said plate (10) and of said reflecting surface (14) and designed to direct a first portion (18) of the light beams (17) towards said edge face (13) and a second portion (19) of said light beams into said layer (15), so that at least a portion of this second portion (19) of light beams is reflected on said reflecting surface (14) to be sent back towards said second planar face (12) of said plate (10).

2. Luminous panel according to claim 1, characterised by the fact that said layer (15) of a transparent medium with an optical index lower than that of the material constituting said plate (10) is a layer of air.

3. Panel according to claim 1, characterised by the fact that the light source means (16), capable of emitting light beams (17), are constituted by at least two light source sub-assemblies (21, 22), each of these sub-assemblies being respectively situated facing the edge face (13) of the plate (10) and facing the edge (23) of the layer (15), so that the beams emitted by these two light source sub-assemblies constitute the two said first and second portions of light beams (18, 19) respectively.

4. Panel according to claim 1, characterised by the fact that said reflecting surface (14) is of the granular type in order to encourage at least one of the two following optical phenomena: reflection and diffusion.

5. Panel according to claim 1, characterised by the fact that it comprises, in addition, a layer (25) for distributing the light being propagated in the plate (10).

6. Panel according to claim 5, characterised by the fact that said light distribution layer (25) is in contact with the second planar face (12) of the plate (10).

7. Panel according to claim 1, characterised by the fact that said plate is constituted by a plate formed from at least one of the following materials: organic glass, PMMA.

8. Display screen of the video type making use of the luminous panel according to claim 1, characterised by the fact that it comprises:
at least one plate (10), formed from a material capable of transmitting, at least partially, light emitted in the visible spectrum, said plate comprising two opposite planar faces, a first face (11) and a second face (12), connected at their periphery by an edge face (13), said first face (11) constituting the display face of the panel,
a reflecting surface (14) disposed facing the second planar face (12) at a non-zero distance so as to form, between itself and this said second planar face, a layer (15) of a transparent medium with an optical index lower than that of the material constituting said plate (10),
light source means (16) capable of emitting light beams (17), at least in the visible spectrum, said light source means being substantially situated at the periphery of said plate (10) and of said reflecting surface (14) and designed to direct a first portion (18) of the light beams (17) towards said edge face (13) and a second portion (19) of said light beams into said layer (15), so that at least a portion of this second portion (19) of light beams is reflected on said reflecting surface (14) to be sent back towards said second planar face (12) of said plate (10), and
an active matrix (40) situated facing the first face (11) of said plate (10).

9. Panel according to claim 2, characterised by the fact that the light source means (16), capable of emitting light beams (17), are constituted by at least two light source sub-assemblies (21, 22), each of these sub-assemblies being respectively situated facing the edge face (13) of the plate (10) and facing the edge (23) of the layer (15), so that the beams emitted by these two light source sub-assemblies constitute the two said first and second portions of light beams (18, 19) respectively.

10. Panel according to claim 2, characterised by the fact that said reflecting surface (14) is of the granular type in order to encourage at least one of the two following optical phenomena: reflection and diffusion.

11. Panel according to claim 3, characterised by the fact that said reflecting surface (14) is of the granular type in order to encourage at least one of the two following optical phenomena: reflection and diffusion.

12. Panel according to claim 2, characterised by the fact that it comprises, in addition, a layer (25) for distributing the light being propagated in the plate (10).

13. Panel according to claim 3, characterised by the fact that it comprises, in addition, a layer (25) for distributing the light being propagated in the plate (10).

14. Panel according to claim 4, characterised by the fact that it comprises, in addition, a layer (25) for distributing the light being propagated in the plate (10).

15. Panel according to claim 2, characterised by the fact that said plate is constituted by a plate formed from at least one of the following materials: organic glass, PMMA.

16. Panel according to claim 3, characterised by the fact that said plate is constituted by a plate formed from at least one of the following materials: organic glass, PMMA.

17. Panel according to claim 4, characterised by the fact that said plate is constituted by a plate formed from at least one of the following materials: organic glass, PMMA.

18. Panel according to claim 5, characterised by the fact that said plate is constituted by a plate formed from at least one of the following materials: organic glass, PMMA.

19. Panel according to claim 6, characterised by the fact that said plate is constituted by a plate formed from at least one of the following materials: organic glass, PMMA.

20. Display screen of the video type making use of the luminous panel according to claim 2, characterised by the fact that it comprises:
at least one plate (10), formed from a material capable of transmitting, at least partially, light emitted in the visible spectrum, said plate comprising two opposite planar faces, a first face (11) and a second face (12), connected at their periphery by an edge face (13), said first face (11) constituting the display face of the panel,
a reflecting surface (14) disposed facing the second planar face (12) at a non-zero distance so as to form, between itself and this said second planar face, a layer (15) of a transparent medium with an optical index lower than that of the material constituting said plate (10),
light source means (16) capable of emitting light beams (17), at least in the visible spectrum, said light source means being substantially situated at the periphery of said plate (10) and of said reflecting surface (14) and designed to direct a first portion (18) of the light beams (17) towards said edge face (13) and a second portion (19) of said light beams into said layer (15), so that at least a portion of this second portion (19) of light beams is reflected on said reflecting surface (14) to be sent back towards said second planar face (12) of said plate (10), and
an active matrix (40) situated facing the first face (11) of said plate (10).
